(19) United States
(12) Patent Application Publication
(10) Pub. No.: US 2001/0003955 A1
(43) Pub. Date: Jun. 21, 2001

(54) Method of presetting printing machines

(76) Inventors: Martin Mayer, Ladenburg (DE); Nikolaus Pfeiffer, Heidelberg (DE)

Correspondence Address: Lerner and Greenberg, P.A., P.O. Box 2480, Hollywood, FL, 33022-2480, US

(21) Appl. No.: 09/732,984

(22) Filed: Dec. 8, 2000

(30) Foreign Application Priority Data
Dec. 8, 1999 (DE) 199 59 244.6
Apr. 10, 2000 (DE) 100 17 800.6

(51) Int. Cl. B41F 5/16; B41F 5/18

(52) U.S. Cl. 101/183; 101/485

(57) ABSTRACT

A method of presetting printing machines is proposed in which a printing standard for each printing machine is defined individually on the basis of an intended use of the printing machine. The ink flows needed in order to print in accordance with the standard for various area coverages of a sample original are determined experimentally. The control circuit of the printing machine on which the determination was carried out is programmed in such a way that, for a predefined area coverage of a printing original, it sets the appropriate ink flow on an inking unit of the printing machine in accordance with the individual standard.

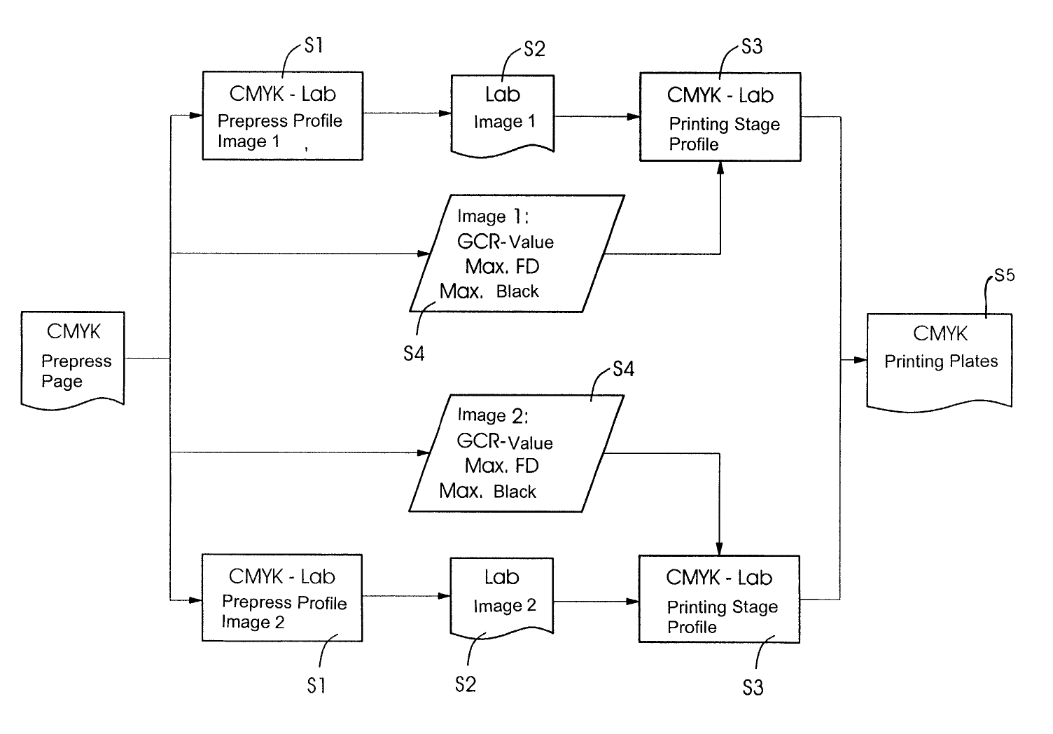

### BACKGROUND OF THE INVENTION

1. Field of the Invention:

The invention relates to a method of presetting printing machines. In order to achieve a high-quality print with good color reproduction of an original, it is necessary to regulate the ink supply into the inking unit of a printing machine precisely in accordance with the ink consumption during printing. Carrying out such regulation by hand is difficult and requires a great deal of experience on the part of the printer, since changes in the ink supply only have an effect on the printed result with a considerable delay. Finding the ink metering suitable for a given print job merely by use of proofs and evaluation of the results is therefore extremely time-consuming and unreliable.

Modern printing machines therefore have control circuits that permit the ink metering to be preset on the basis of previously measured parameters of the printing original. These control circuits operate with characteristic curves which, for example, for a specific area coverage of a given color in the image to be printed, specify ink flows using ink-zone openings and ink-strip widths. The ink flows being suitable to obtain the area coverage during continuous printing with a defined full-tone density. The manufacturer normally determines the characteristic curves for a series of printing machines on the basis of printing trials with a machine from this series which is viewed as being typical and adjusted optimally, and uses the results for all machines in the series, or he carries out such printing trials for a limited number of machines from the series and obtains the characteristic curves by averaging the results obtained. If the measuring values determined on the basis of these characteristic curves for a given print original are set on the printing machine before the start of printing, it should be possible, in the ideal case, to print with good color reproduction from the beginning of a print job, or at least to reduce considerably the number of trials which are needed in order to find the optimum setting of the printing machine.

The values that the full-tone densities are to have can in principle be defined arbitrarily within certain limits. If the full-tone densities are specified too low, the result is an undesirably low-contrast printed image. On the other hand, the full-tone densities cannot be defined to be arbitrarily high, since the various colors can be overprinted only with limited layer thicknesses and, with high full-tone densities, the tonal value gain also rises undesirably sharply.

The fact that each printing shop is able to define its full-tone density freely, in principle, results in the possibility of distinctly different imprints in terms of color reproduction arising from one and the same printing original in various printing shops. In order to eliminate this problem, which is burdensome for individual clients, efforts are underway to standardize the printing process, in particular to define generally mandatory full-tone densities. If each printing shop were to operate in accordance with such a standard, the printed results from various printing shops would in principle be identical. The existence of standards is also a condition for the presetting of printing machines to lead to satisfactory results. Setting up a characteristic curve for the ink metering is only possible if the full-tone density to be achieved on the printed result is known. Consequently, a manufacturer of printing machines is also compelled to define a printing standard.

This is opposed by the interest of the printing shops who have to work with a wide variety of different printing materials, inks, etc. for extremely diverse applications. Thus, for example, the printing of board packaging can make different inks, rubber blankets, printing speeds, etc. necessary from those used to print posters or magazines. The printing shops are therefore often compelled to deviate from the predefined printing standards in order to achieve optimum results.

Presetting merely on the basis of the characteristic curves preprogrammed by the manufacturer in the control circuit of the printing machine is therefore not possible. The settings selected by the control circuit on the basis of the characteristic curves have to be recorrected in order to achieve the desired printed result.

The technical journal for the printing industry and communications technology, special edition, titled “Der Polygraph”, 03-88, discloses a method (Pixon-PCT) for presetting printing machines in which, from a universal CMYK color correction database, set up once, color separations for various printing processes, such as offset, flexographic or gravure printing, or printing conditions, such as different printing materials, printing inks, printing-machine characteristics, printing plates etc. can optionally be produced by the operator. The conversion of the universal database to other printing conditions and/or printing processes is carried out with the aid of previously calculated color transformation tables. In this method therefore, only the standard of one printing process or of one printing condition is taken into account when setting the color.

### SUMMARY OF THE INVENTION

It is accordingly an object of the invention to provide a method of presetting printing machines which overcomes the above-mentioned disadvantages of the prior art methods of this general type, which makes it possible for any operator of a printing machine to operate with presettings which are matched optimally to his specific requirements.

With the foregoing and other objects in view there is provided, in accordance with the invention, a method of operating printing machines. The method includes the steps of defining desired values for each printing machine individually on a basis of an intended use for an entire printing process; and calibrating a color control of the printing machine and a prepress stage to the desired values.

The object is achieved in that desired values of the area density to be printed are defined individually for each printing machine on the basis of the intended use of the printing machine. The color control of the printing machine and the prepress stage is calibrated to these desired values. Such a calibration should expediently also include speed compensation.

Ink flows that are required for printing in accordance with a standard with the individually defined area densities are preferably determined on the same printing machine whose control circuit is subsequently programmed on the basis of the experimentally determined ink flows. Individual scatter in the behavior of the printing machines, for example in the ink-strip width or ink-zone opening set for a given desired value on the basis of tolerances in the actuators used, continue to have no effect on the printed result, because of the individual adaptation. All the relevant parameters of the printing process can be selected freely for the standard from the point of view of expediency. Therefore, for the experimental determination of ink flows, that printing material for which the printing machine is essentially to be used would generally be selected which is essentially to be used for the printing machine, and for this printing material a suitable printing speed, a suitable rubber blanket etc. can be selected.

A further reason why a printing machine having a control circuit preprogrammed exclusively by the manufacturer does not supply optimum results may be changes in the metering behavior of the machine which originate from influences during the transport or the set-up at its place of use. Changes of this type can be compensated for without difficulty by the experimental determination being carried out only after the machine has been set-up at its place of use.

It is not absolutely necessary for a machine of this type to be preprogrammed by the manufacturer. Preprogramming of this type in accordance with a standard of the manufacturer can, however, simplify the measurements which are necessary for the individual programming of the machine, since the presettings in accordance with standard programming in any case represent a good first approximation to the settings required to print in accordance with the individual standard.

In accordance with an added feature of the invention, there is the step of calibrating a color presetting.

In accordance with an additional feature of the invention, there is the step of calibrating a speed compensation.

In accordance with another feature of the invention, there is the step of carrying out the calibrating of the prepress stage step using color management curves and/or copying characteristic curves.

In accordance with a further feature of the invention, there is the step of setting-up a job change such that the desired values are reached quickly after the job change.

In accordance with another added feature of the invention, there are the steps of determining, experimentally, ink flows required for printing in accordance with an individual standard with individually defined area densities for various area coverages of a sample printing original resulting in experimentally determined ink flows. And programming a control circuit of the printing machine using the experimentally determined ink flows such that, for a predefined area coverage of the sample printing original, the control circuit sets an appropriate ink flow on an inking unit of the printing machine.

In accordance with another additional feature of the invention, there is the step of carrying out an experimental determination of the ink flows on the printing machine also having the control circuit that is subsequently programmed by using the experimentally determined ink flows.

In accordance with a further added feature of the invention, there is the step of carrying out the experimental determination of the ink flows after the printing machine has been set-up at its place of use.

In accordance with a further additional feature of the invention, there is the step of preprogramming the control circuit in advanced by a manufacturer in accordance with a general standard.

In accordance with an added feature of the invention, during the experimental determination of the ink flows, presettings that the control circuit makes by using the preprogramming are optimized with regard to compliance with the individual standard.

In accordance with a concomitant feature of the invention, the individual standard deviates from the general standard in at least one of the following parameters: a type of printing material, a type of rubber blanket, a printing speed, a sequence of colors, inks used, standard ink densities, and a tonal gain.

Other features which are considered as characteristic for the invention are set forth in the appended claims.

Although the invention is illustrated and described herein as embodied in a method of presetting printing machines, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The single figure of the drawing is a block flow diagram of a presetting process according to the invention.

### DESCRIPTION OF THE PREFERRED EMBODIMENT

A first step in a method for presetting a printing machine is that the operator of the machine defines a printing material to which a standard is to be referred. This is expediently the printing material that is used most frequently in the machine.

For the printing material and for each color used, inking standards, such as full-tone densities or Lab values, are defined. The full-tone densities used by Heidelberger Druckmaschinen are specified as examples in Table 1. The values used by the printing machine can be the same or can deviate in the case of one or more colors.

TABLE 1

| | Paper type | | |
|---|---|---|---|
| | Glossy | | |
| | coated | Matt coated | Uncoated |
| Black | 1.80 ± 4% | 1.45 ± 4% | 1.10 ± 4% |
| Cyan | 1.55 ± 4% | 1.35 ± 4% | 1.05 ± 4% |
| Magenta | 1.55 ± 4% | 1.35 ± 4% | 1.05 ± 4% |
| Yellow | 1.40 ± 4% | 1.20 ± 4% | 0.95 ± 4% |

The printing speed is defined at a value that corresponds to a preferred speed for the main use of the machine. Then, for a number of printing plates each having different area coverages and for different ink-strip widths, proofs are used to determine the ink-zone opening which is necessary to achieve the ink density predefined in accordance with the individual standard.

The ink-zone openings determined in the various printing operations are recorded. Using the ink-zone openings obtained in this way, in each case as a function of the area coverage and the ink-strip width, a characteristic curve for the printing machine can be calculated. The calculations can be carried out by the operator of the printing machine, it being possible for him to use the same algorithms for the calculation of the characteristic curves as the manufacturer has previously already used for the calculation of the standard characteristic curves.

Changes in the printing speed of the machine can result in color changes in the printed product. Good speed compensation must be capable of compensating for this. A series of trials is therefore carried out and, to prepare for them, the ink-strip width is set to a low value and the ink-zone opening is adjusted to a value that is suitable for printing with the individually specified full-tone densities at the selected standard speed. The series of trials contains a plurality of printing trials in which only the printing speed is varied. On the sheet printed in this process, the ink densities are measured as a function of the printing speed, and correction factors for the ink supply are determined, which permit a constant full-tone density to be maintained irrespective of the printing speed. Here, too, the evaluation of the printed sheets and the calculation of the correction factors can be carried out by the manufacturer, while the trials themselves are carried out at the premises of the user of the machine and by the user.

The result of this procedure is that a “primary” characteristic curve, which specifies the necessary ink flow as a function of the area coverage, is referred to the preferred printing speed, while other speeds, which are used less frequently, will be given “secondary” characteristic curves by multiplying the determined correction factors by the primary characteristic curve. As a result, the behavior of the printing machine at the preferred speed can be described more exactly with the aid of characteristic curves than at all other speeds. As distinct from the presetting in accordance with a general standard, it is therefore ensured that the most precise presetting of the printing machine on the basis of the characteristic curves is always possible for the conditions of use which have the greatest practical significance.

Further measurements relate to the optimization of a job change. At the beginning or before the beginning of the processing of a print job, it is desirable to be able to bring the inking unit of the printing machine as quickly as possible into a state which is as equal as possible to the continuous printing state. If the inking unit has previously been washed, it is therefore initially necessary for a specific quantity of ink to be metered into the inking unit, in order to build up in the latter an ink layer thickness which corresponds to the ink layer thickness present during continuous printing. Metering is carried out, for example, by a specific number of ductor cycles being run through before the start of printing, during which cycles the ductor roll in each case picks up a portion of ink from the ductor and transfers it into the inking unit.

A number of ductor cycles predefined by the manufacturer of the printing machine in his general standard, and with which an ink layer for printing with the tonal density likewise defined in accordance with the general standard is possible, does not necessarily have to be suitable to build up a layer thickness which is also suitable for individually differently defined tonal densities or printing speeds. A number of trials are therefore carried out, in each case for printing plates with different area coverage values, in which in each case first of all ink-zone openings and ink-strip widths are adapted in such a way that the tonal densities, selected in accordance with the individual standard, are achieved during continuous printing. The inking unit is then washed and ink is fed in, the number of ductor cycles carried out before the start of printing differing from one trial to another. In each trial, about 100 sheets are printed. If the number of ductor cycles was too low, an increase in the tonal density will be observed over these 100 sheets; if the number of ductor cycles was too high, the tonal density decreases. Two to three trials with different numbers of ductor cycles suffice to determine the optimum number of ductor cycles, if necessary by interpolation.

For a quick job change without washing the inking unit the ink layer thicknesses in the inking unit should be reduced to a basic layer thickness toward the end of a print job. For this purpose the ductor must be thrown off before the end of the job, and the last sheets of the job are printed without any ink supply. The number of these sheets is different for each inking unit. In order to determine the number for the individually defined standard, first of all an initial value for the number of sheets to be printed after the ductor has been switched off is selected, it being possible for this value to correspond to that provided by the manufacturer in accordance with the general standard, for example. After the corresponding number of sheets have been printed, a printing plate with a low area coverage of 5%, for example, is fitted, and the rubber blankets of the printing machine are washed but not the inking units, in order not to disrupt the inking profile in them. Then, using the plate newly clamped in, printing is carried out without any supply of ink. Since, as a result of this low-coverage plate, the ink layer in the inking unit is removed only slowly, the reduction in the ink layer on the printed sheets can be observed at high resolution, and the number of sheets which would have to be printed in normal operation, that is to say without changing the printing plate, in order to reduce the inking profile, can be calculated by using the relationship between the coverage ratios of the printing plates.

If, after the conclusion of a print job and corresponding reduction in the inking profile, a new print job is to be carried out, an inking profile suitable for this must be built up by putting ink into the unwashed inking unit. As in the case of putting ink into the washed inking unit, for this purpose a number of ductor cycles is carried out, without any printing being carried out and therefore without any ink being removed from the inking unit. The number of cycles needed for this is determined in the same way as in the case of the washed inking unit.

Using the data obtained in this way, a family of characteristic curves can be calculated, which in each case specify, for a predefined area coverage and ink-strip width, the ink-zone openings necessary in order to print in accordance with the individually defined standard. The control circuit is reprogrammed by characteristic curves and ductor-cycle numbers stored in it for the input of ink and the reduction in accordance with the general standard being replaced by the values obtained by using the above-described measurements.

In order to achieve good printed results with the individually defined standard, it is generally necessary for the prepress stage, in particular the exposure of the printing plates, to be calibrated to this standard as well. This can be done by a color management method, which is based directly on carrying out the exposure of a location on the printing plate in such a way that the shade of the original is reproduced exactly, or the tonal values of the printing inks for the affected location on the original can be recorded by measurement, and the exposure for the location on the printing plate is metered on the basis of copying characteristic curves in such a way that the appropriate tonal value is reproduced in the print.

The operating method described here makes it possible to preset the printing machine directly, on the basis of parameters registered on a printing original, in such a way that printing in accordance with the standard adapted individually to the requirements of the printer is possible. Change-over times are shortened in this way, and misprints are avoided.

In the following text, using the single figure of the drawing, an exemplary embodiment of a color management method in a cyan, magenta, yellow and carbon black (CMYK) workflow will be explained in more detail. The starting point is a standardized CMYK data set, which is determined in advance for the respective printing machine. The test page in the CMYK format is here broken down into images 1 and 2, with which the procedure is subsequently identical, so that in the following text only the conversion of the process-independent data for image 1 will be explained in more detail. The CMYK values are converted into Lab values in a first step S1 by use of the CMYK-Lab profile with which the CMYK image has originally been separated. The result of this is that the colorimetric appearance of the image 1 can be seen, step S2. The Lab values are then re-separated by the CMYK-Lab profile of the current printing process, step S3. During the transformation into the Lab color space, the information on the black build-up is lost. Therefore, during the transformation from Lab into CMYK, the black build-up of the original CMYK data is used if the starting and target process are identical, for example from offset printing to offset printing. If the processes are different, for example from gravure printing to offset printing, the black build-up is adapted to the target process. Information about the black build-up is, for example, the gray-color-removal (GCR) value, the maximum ink density FDₘₐₓ, the maximum blackness, etc, step S4. The presettings determined in this way and suitable for the print job are used as a basis for setting up the printing plates in the CMYK format, step S5.

We claim:

1. A method of operating printing machines, which comprises the steps of:
defining desired values for each printing machine individually on a basis of an intended use for an entire printing process; and
calibrating a color control of the printing machine and a prepress stage to the desired values.

2. The method according to claim 1, which comprises calibrating a color presetting.

3. The method according to claim 1, which comprises calibrating a speed compensation.

4. The method according to claim 1, which comprises carrying out the calibrating of the prepress stage step using at least one of color management curves and copying characteristic curves.

5. The method according to claim 1, which comprises setting-up a job change such that the desired values are reached quickly after the job change.

6. The method according to claim 1, which comprises:
determining, experimentally, ink flows required for printing in accordance with an individual standard with individually defined area densities for various area coverages of a sample printing original resulting in experimentally determined ink flows; and
programming a control circuit of the printing machine using the experimentally determined ink flows such that, for a predefined area coverage of the sample printing original, the control circuit sets an appropriate ink flow on an inking unit of the printing machine.

7. The method according to claim 6, which comprises carrying out an experimental determination of the ink flows on the printing machine also having the control circuit that is subsequently programmed by using the experimentally determined ink flows.

8. The method according to claim 7, which comprises carrying out the experimental determination of the ink flows after the printing machine has been set-up at its place of use.

9. The method according to claim 6, which comprises preprogramming the control circuit in advanced by a manufacturer in accordance with a general standard.

10. The method according to claim 9, which comprises during the experimental determination of the ink flows, presettings that the control circuit makes by using the preprogramming are optimized with regard to compliance with the individual standard.

11. The method according to claim 9, wherein the individual standard deviates from the general standard in at least one of the following parameters:
a type of printing material;
a type of rubber blanket;
a printing speed;
a sequence of colors;
inks used;
standard ink densities; and
a tonal gain.
